(19) United States
(12) Patent Application Publication
(10) Pub. No.: US 2006/0280138 A1
(43) Pub. Date: Dec. 14, 2006

(54) Wireless access point repeater

(75) Inventors: Sameer Nanda, Cupertino, CA (US); Naren Bhat, Fremont, CA (US); Paul Sidenblad, Cupertino, CA (US); Thomas Maufer, Menlo Park, CA (US)

Correspondence Address: BERKELEY LAW & TECHNOLOGY GROUP, 1700NW 167TH PLACE, SUITE 240, BEAVERTON, OR, 97006, US

(73) Assignee: nVidia Corporation

(21) Appl. No.: 11/152,267

(22) Filed: Jun. 13, 2005

(51) Int. Cl. H04J 3/16; H04J 3/22; H04L 12/56; H04L 12/28; H04Q 7/00; H04B 7/14; H04J 3/08; H04J 1/10

(52) U.S. Cl. 370/315; 370/328; 370/466

(57) ABSTRACT

Embodiments related to wireless access point repeaters are disclosed.

### FIELD

This application pertains to the field of wireless networks, and more particularly, to the field of wireless access point repeaters.

### BACKGROUND

Wireless local area networks (WLAN) may include an access point that is connected to an Ethernet local area network (LAN) or to the Internet through a wired connection. The access point may allow one or more WLAN stations to access the Ethernet LAN or the Internet over wireless connections that couple the stations to the access point. A repeater access point may be added in order to increase the range of the WLAN or to couple together multiple WLANs. The repeater access point may communicate with the original access point over a wireless connection. At their discretion, WLAN stations may associate with either the original access point or the repeater access point.

One difficulty encountered when adding a repeater access point to a WLAN is configuring communications between the repeater access point and the original access point, thereby allowing stations to communicate with the original access point through the repeater access point. The configuration may require extensive user input and/or proprietary access point discovery protocols. Additional difficulties may be encountered if a station is moved from one part of the WLAN to another.

### BRIEF DESCRIPTION OF THE DRAWING

The claimed subject matter will be understood more fully from the detailed description given below and from the accompanying drawings of embodiments which should not be taken to limit the claimed subject matter to the specific embodiments described, but are for explanation and understanding only.

FIG. 1 is a block diagram of an example WLAN including an example embodiment of a repeater access point.

FIG. 2 is a diagram depicting example data frame headers transmitted from a remote station to a repeater access point and from the repeater access point to a distant access point.

FIG. 3 is a diagram depicting example data frame headers transmitted from a distant access point to a repeater access point and from the repeater access point to a remote station.

FIG. 4 is a block diagram of an example WLAN including an example embodiment of a repeater access point coupled to a distant access point and further including a plurality of stations.

FIG. 5 is a diagram depicting example unicast frame headers transmitted from a station to a repeater access point, from the repeater access point to a distant access point, and from the distant access point to a second station.

FIG. 6 is a diagram depicting example unicast frame headers transmitted from a station to a distant access point, from the distant access point to a repeater access point, and from the repeater access point to a second station.

FIG. 7a is a diagram depicting example broadcast frame headers transmitted from a station to a repeater access point and from the repeater access point to a distant access point.

FIG. 7b is a diagram depicting example broadcast frame headers transmitted from a distant access point station to a repeater access point and to a station and from the repeater access point and the station to second and third stations.

FIG. 8 is a diagram depicting example broadcast frame headers transmitted from a station to a distant access point, from the distant access point to a repeater access point, and from the repeater access point to second and third stations.

FIG. 9a is a diagram depicting example address resolution protocol frame headers transmitted from a station to a repeater access point and from the repeater access point to a distant access point.

FIG. 9b is a diagram depicting example address resolution protocol frame headers transmitted from a distant access point to a repeater access point and from the repeater access point to a first station and a second station.

FIG. 10 is a flow diagram of an example embodiment of a method for communicating frame headers from a distant access point to a remote station through a repeater access point.

FIG. 11 is a block diagram of an example WLAN including an example embodiment of a computer system.

FIG. 12 is a block diagram of an example embodiment of a computer system including a repeater access point.

### DETAILED DESCRIPTION

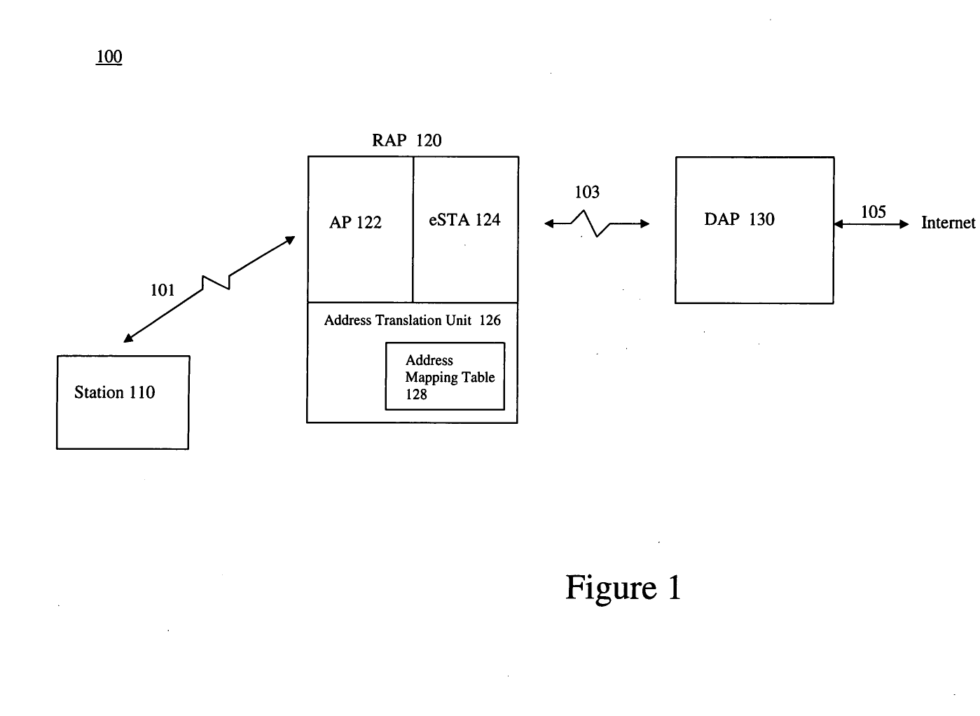

FIG. 1 is a block diagram of an example embodiment of a WLAN 100 including a repeater access point (RAP) 120. RAP 120 is coupled to a station 110 and a distant access point (DAP) 130 via wireless interconnects 101 and 103, respectively. DAP 130 for this example embodiment provides access to the Internet via a wired connection 105. Station 110 may comprise any of a wide range of devices, including, but not limited to, notebook computers, desktop computers, personal digital assistants, cellular phones, etc.

As used herein, the term “distant access point” is meant to denote an access point that is logically situated between a repeater access point and a LAN, the Internet, or other type of network. Also as used herein, the term “remote station” is meant to denote a station that communicates with a distant access point through a repeater access point. Station 110 for this example may be considered to comprise a remote station.

The wireless interconnects discussed herein in connection with the various example embodiments may adhere to the Institute of Electrical and Electronics Engineers (IEEE) 802.11 standard. Other embodiments may adhere to different communications protocols and/or standards.

RAP 120 for this example embodiment includes an access point (AP) 122 to provide communication with station 110, an embedded station (eSTA) 124 to provide communication with distant access point 130, and an address translation unit 126. Address translation unit 126 for this example embodiment includes an address mapping table 128.

ESTA 124 may be distinct from an internal station (not shown) that may be part of AP 122. ESTA 124 may associate with DAP 130 and may be included as part of the DAP's basic service set (BSS). For this example, the DAP's BSS includes DAP 130 and eSTA 124. Station 110 and AP 122 are included in the RAP's BSS. Thus, RAP 120 may operate simultaneously in both the DAP's BSS and the RAP's BSS.

Station 110 may be associated with either AP 122 or DAP 130 since each operates as an access point. Station 110 may select the access point from which it receives a stronger signal, or it may use any other metric to make the choice of access point with which it will associate. For this example, station 110 is associated with AP 122.

When AP 122 receives a frame from station 110, RAP 120 forwards the frame to DAP 130 via eSTA 124 if the frame is not addressed to another station (not shown) that is associated with AP 122. If the frame is encrypted, RAP 120 may decrypt the frame and may modify one or more address fields. A basic service set identification (BSSID) field may be changed from the RAP BSSID to the DAP BSSID, and a source address field may be changed from station 10's medium access control (MAC) address to the MAC address identifying eSTA 124. RAP 120 may then re-encrypt the modified frame (if previously decrypted) and transmit the modified frame to DAP 130.

As used herein, the term “medium access control address” is meant to include any of a wide range of techniques and/or methods for uniquely identifying a node in a network, and is not limited to embodiments that adhere to the IEEE 802.11 standard. MAC addresses may be fixed in hardware or stored in non-volatile memory.

When RAP 120 receives a frame from DAP 130, the MAC destination address may indicate the eSTA 124 as the destination but the frame may be ultimately intended for station 110. Address translation unit 126 may access address mapping table 128 to determine a MAC address for station 110 based on a protocol destination address included as part of the received frame header. Address mapping table 128 for this example includes a plurality of entries that maintain protocol address-to-MAC address information. It is also possible that eSTA 124 will discover that it is the intended final destination for this frame, in which case the frame is not forwarded beyond RAP 120.

Although the embodiments discussed herein for repeater access points utilize address mapping tables to maintain protocol address-to-MAC address information, other embodiments are possible that use other techniques, devices, methods, and/or components for maintaining protocol address-to-MAC address information.

The protocol addresses discussed herein may adhere to the Internet Protocol (IP) version 4 or version 6. The MAC addresses may adhere to the IEEE 802.11 standard. Other embodiments are possible that use address schemes that adhere to different standards and/or protocols.

The address mapping information for address mapping table 128 may be gleaned by snooping address resolution protocol (ARP) request frames that may adhere to the IETF (Internet Engineering Task Force) RFC-826 standard and/or by monitoring neighbor discovery packets that may adhere to the IP version 6 protocol. ARP frames and neighbor discovery packets may include MAC addresses and corresponding IP addresses. Other methods for gleaning address mapping information are possible, including monitoring Dynamic Host Configuration Protocol (DHCP) exchanges.

RAP 120 for this example embodiment may be manually configured by a user with the MAC address of DAP 130, or RAP 120 may discover DAP 130 by an active or passive scan. RAP 120 for this example embodiment would only need manual configuration in the event that it is near more than one distant access point.

The functions described herein in connection with repeater access points may be performed using hardware, software, or firmware, or a combination of hardware, software, and/or firmware.

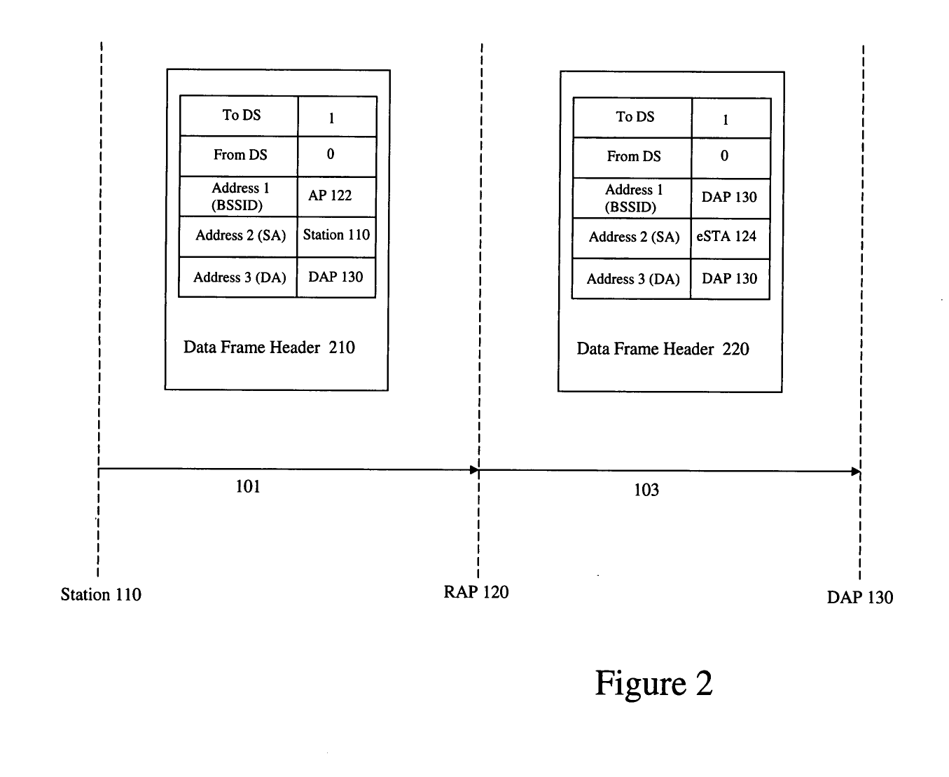

FIG. 2 is a diagram depicting an example data frame header 210 that is part of a frame that is transmitted from station 110 to repeater access point 120 via interconnect 101 and an example data frame header 220 that is part of a frame transmitted from the repeater access point 120 to distant access point 130 via interconnect 103. Header 220 for this example is a modified version of header 210.

Header 210 includes a To Distribution System (DS) field, which for this example header is set to the value “1.” A From DS field contains the value “0.” A distribution system (DS) is a logical architectural concept that may facilitate the integration of more than one BSS to form an extended service set. For this example embodiment, a DS may logically couple eSTA 124 and DAP 130.

Three address fields are included in header 210. The Address 1 field includes a BSSID value for AP 122. The Address 2 field contains a MAC source address identifying station 110 as the source of the frame. The Address 3 field contains a MAC destination address identifying DAP 130 as the destination for the frame.

Header 210 is received at AP 122, and RAP 120 modifies the contents of the address fields to create a modified header (data frame header 220) that is part of a frame transmitted to DAP 130. The BSSID value is changed from the BSSID value for AP 122 to a BSSID value for DAP 130. The MAC source address field is changed from the MAC address for station 110 to the MAC address identifying eSTA 124. The MAC destination address is not changed and continues to indicate that the destination for the frame is DAP 130. A value of “1” in the To DS field and a value of “0” in the From DS field may cause DAP 130 to identify the frame as coming from a locally associated station (in this case eSTA 124). Thus, even though the frame originated at station 110, to DAP 130 it appears that the frame originated at RAP 120.

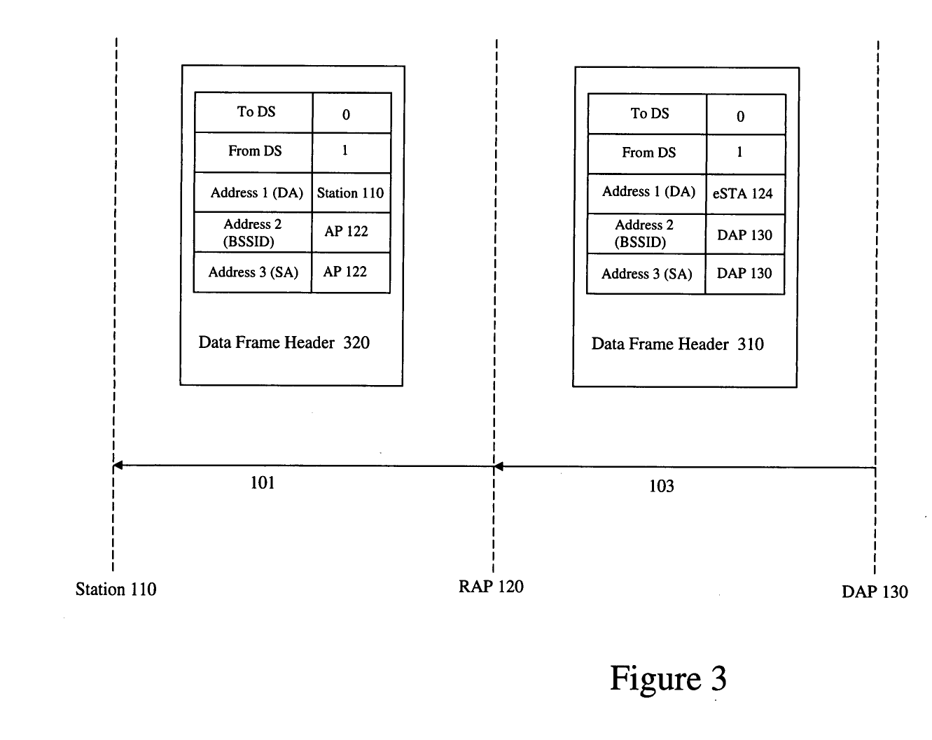

FIG. 3 is a diagram depicting an example data frame header 310 that is part of a frame transmitted from DAP 130 to RAP 120 via interconnect 103 and an example data frame header 320 that is part of a frame transmitted from RAP 120 to remote station 110 via interconnect 101. For header 310, the To DS field has the value of “0” and the From DS field has the value of “1,” indicating that DAP 130 is treating the frame as being transmitted to a locally associated station (eSTA 124 in this case) even though the frame for this example is destined for station 110, which for this example cannot be determined solely by looking at the contents of the frame's IEEE 802.11 header information.

The Address 1 field contains a MAC destination address which for header 310 has a value identifying eSTA 124 as the destination. Address 2 contains a BSSID value which for example header 310 has a value identifying the DAP 130 BSS. Address 3 contains a MAC source address value which for this example header 310 has a value identifying DAP 130 as the source of the frame.

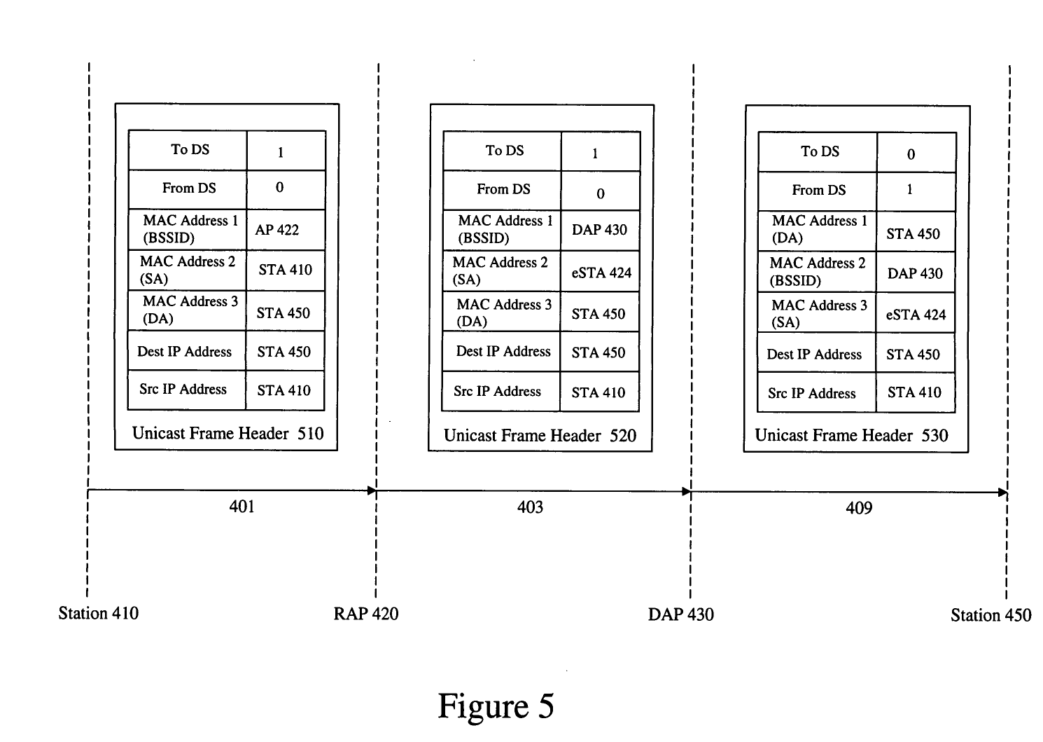

Header 310 is received at RAP 120. RAP 120 creates a modified header (data frame header 320 for this example) by changing the values of the address fields. RAP 120 for this example cannot tell from looking at the MAC destination address field of header 310 where to forward the frame. RAP 120 uses IP destination address information (not shown, but see FIGS. 5-9 and the associated discussion below) in the header 310 to perform a look-up into the address mapping table 128 to determine the appropriate MAC destination address for the frame. For this example, the MAC destination address is changed from a value indicating eSTA 124 in header 310 to a value identifying station 110 in header 320. The BSSID value is changed from a value indicating DAP 130 to a value indicating AP 122. The MAC source address field is changed from a value indicating DAP 130 to a value indicating AP 122.

A frame including header 320 is received by station 110 and station 110 recognizes that it is the intended recipient due to the value of the MAC destination address field that now shows a value identifying station 110. To station 110, it appears as though the frame originated at AP 122 due the value of the MAC source address field even though the frame actually originated at DAP 130.

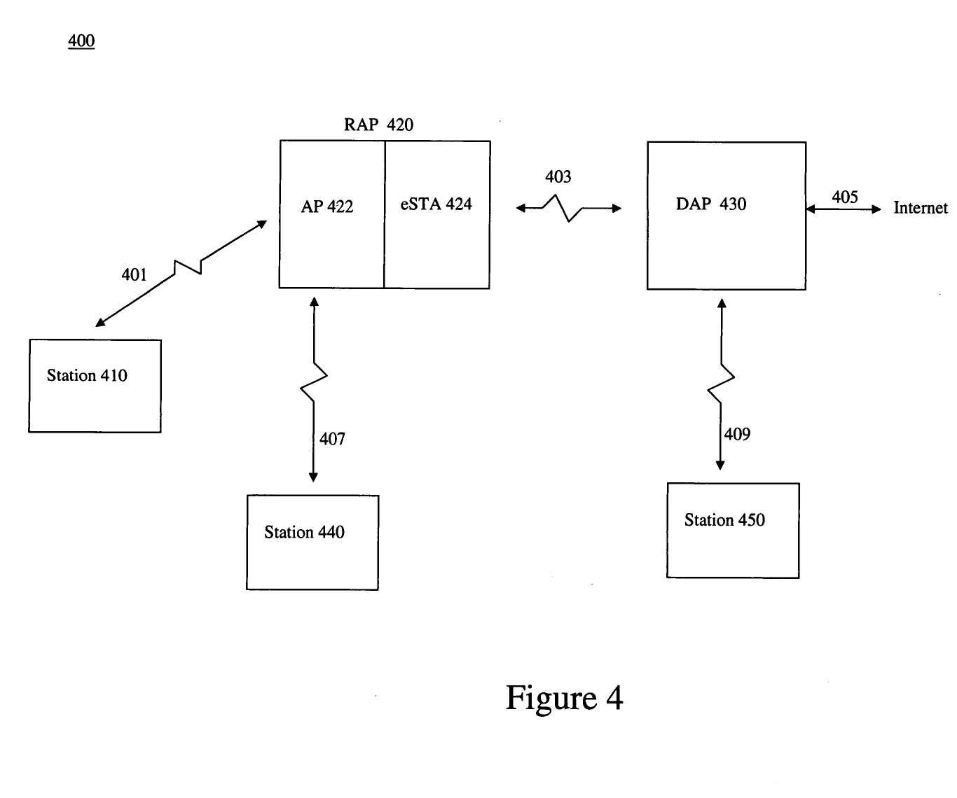

FIG. 4 is a block diagram of an example WLAN 400 including an example embodiment of a repeater access point 420 coupled to a distant access point 430 and further including remote stations 410 and 440, which are associated with RAP 420, as well as station 450 that is local to DAP 450. RAP 420 may be implemented in a manner similar to RAP 120, discussed above. RAP 420 for this example includes an AP 422, an eSTA 424, and an address translation unit (not shown). RAP 420 is coupled to station 410 and station 440 via wireless interconnects 401 and 407, respectively. RAP 420 communicates with DAP 430 via wireless interconnect 403. Station 450 is coupled to DAP 430 via wireless interconnect 409. DAP 430 for this example is coupled to the Internet via a wired interconnect 405.

Stations 410, 440, and 450 may comprise any of a wide range of devices, including, but not limited to, notebook computers, desktop computers, personal digital assistants, cellular phones, etc.

FIG. 5 is a diagram depicting an example header that is part of a unicast frame as it is transmitted from station 410 to station 450 through RAP 420 and DAP 430. A unicast frame is a frame that has a single designated destination. Station 410 transmits a unicast frame including header 510 to RAP 420 over wireless interconnect 401. Header 510 includes a To DS field, a From DS field, three MAC address fields, a destination IP address, and a source IP address field. For this example, the To DS field has a value of ‘1’ and the From DS field has a value of ‘0’. MAC address 1 has a BSSID value that identifies the AP 422 BSS. MAC address 2 has a source address that identifies station 410. MAC address 3 has a destination address that identifies station 450. The destination IP address has a value that identifies station 450, and the source IP address has a value that identifies station 410.

When RAP 420 receives header 510, it looks at the MAC address 3 field and determines that the identified destination station is not associated locally to AP 422. RAP 420 then pipes the frame associated with header 510 to eSTA 424 to be transmitted to DAP 430 via interconnect 403. Before transmitting the frame to DAP 430, the MAC address fields are modified to create unicast frame header 520. The BSSID value is changed to identify the DAP 430 BSS, and the MAC source address value is changed to identify eSTA 424.

DAP 430 receives header 520 and the frame associated with header 520. DAP 430 looks at the MAC address 3 value and determines that the identified destination station is a station (station 450) that is locally associated with DAP 430. DAP 430 creates unicast frame including header 530 for transmission to station 450 over interconnect 409. Because the frame associated with header 530 is to be transmitted away from DAP 430, the To DS field is changed to hold a value of ‘0’ and the From DS field is changed to hold a value of ‘1’. MAC address 1 contains a MAC destination address value that identifies station 450. MAC address 2 contains a BSSID value that identifies the DAP 430 BSS. MAC address 3 contains a source address value that identifies eSTA 424. By manipulating the frame's IEEE 802.11 headers, and by maintaining an address mapping table, the repeater access point may ensure that it is invisible to the remote stations and to the distant access point. Thus, in this example the destination and source IP headers are not changed by the repeater access point 420 in routing the frame from station 410 to station 450.

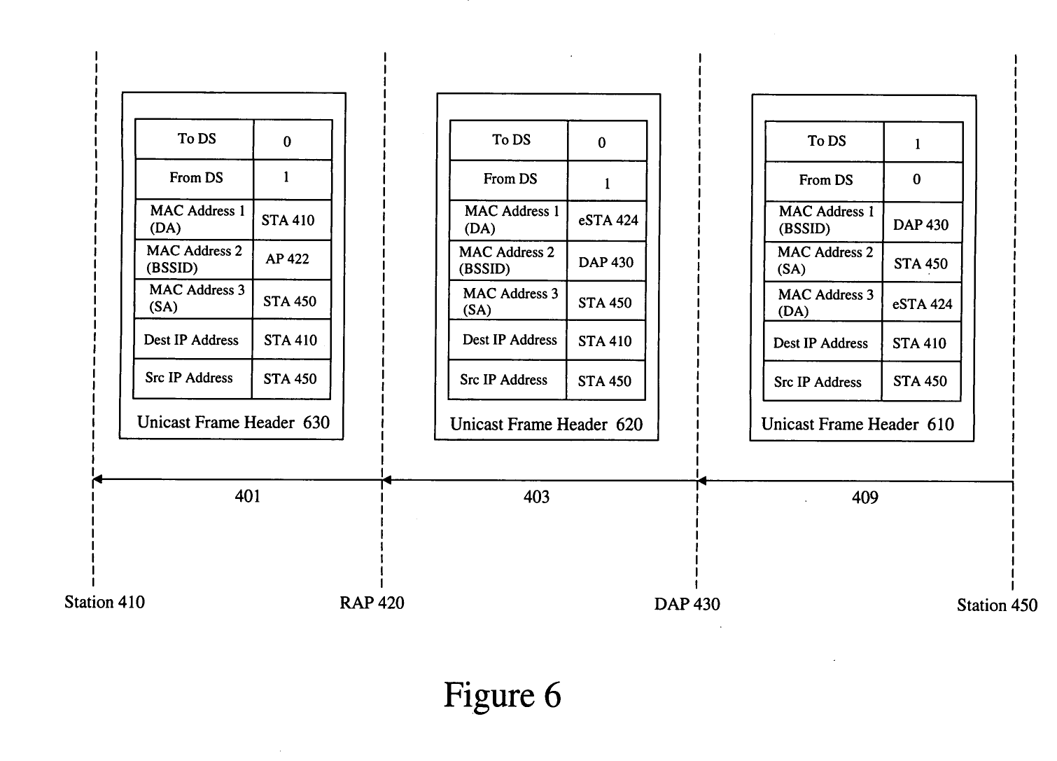

FIG. 6 is a diagram depicting an example header associated with a unicast frame as it is transmitted from station 450 to station 410 through DAP 430 and RAP 420. Unicast frame header 610 is prepared by station 450. For example header 610, the To DS field has the value ‘1’ and the From DS field has the value ‘0’. MAC address 1 contains a BSSID value that identifies the DAP 430 BSS. MAC address 2 contains a MAC source address value that identifies station 450. MAC address 3 contains a MAC destination address that identifies eSTA 424. The destination IP address field indicates that station 410 is the intended recipient of the frame. The source IP address field identifies station 450 as the source of the frame. Station 450 transmits a frame including header 610 to DAP 430.

DAP 430 receives header 610 and looks at the MAC address 3 field to determine where to route the frame. Because the MAC address 3 field contains a value that identifies eSTA 424 as the destination, DAP 430 prepares a frame including a header 620 for transmission to eSTA 424 via interconnect 403. Header 620 includes a To DS field with a value of ‘0’, and a From DS field with a value of ‘1’. MAC address 1 contains a MAC destination address that identifies eSTA 424. MAC address 2 contains a BSSID value that identifies the DAP 430 BSS. MAC address 3 contains a MAC source address that identifies station 450. DAP 430, acting as an IEEE 802.11 access point, ignores the destination IP address field which continues to indicate that station 410 is the intended recipient of the frame and the source IP address field that also continues to indicate that station 450 is the source of the frame.

Header 620 is received at RAP 420. Because the MAC destination address field contains a value that identifies eSTA 424 as the destination, and because all frames received at RAP 420 from DAP 430 will show eSTA 424 as the destination, RAP 420 uses the information in the destination IP address field to determine the MAC address of the intended recipient identified in the destination IP address field. RAP 420 may use the destination IP address information to access the appropriate MAC destination address from an address mapping table. For this example, the destination IP address field shows that station 410 is the intended recipient, and RAP 420 uses this information to determine the appropriate value to place in the MAC destination address field of header 630.

Header 630 maintains a value of ‘0’ in the To DS field, and also maintains a value of ‘1’ in the From DS field. As previously mentioned, MAC address 1 contains a MAC destination address value that identifies station 410. MAC address 2 contains a BSSID value that identified the AP 422 BSS. MAC address 3 contains a MAC source address value that identifies station 450. The destination IP and source IP address fields continue to contain values that identify station 410 and station 450, respectively.

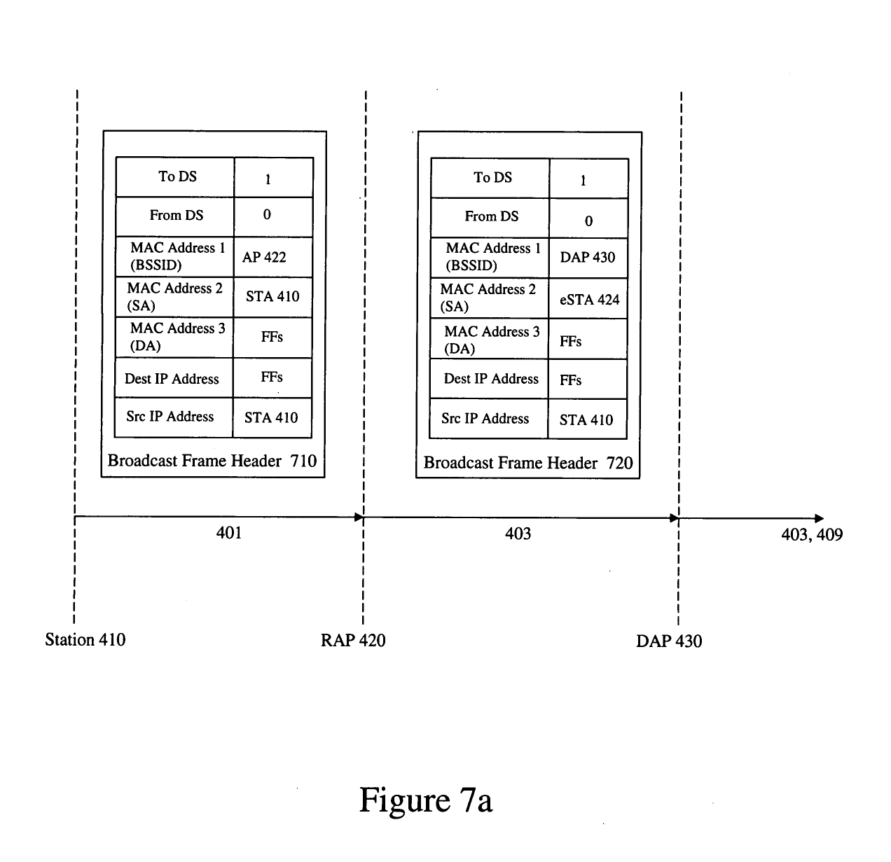

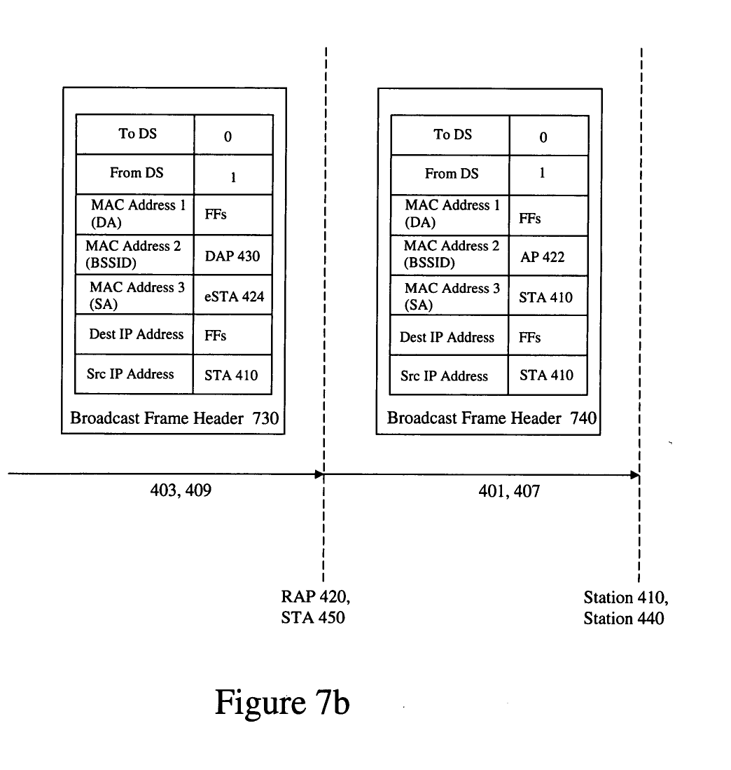

FIG. 7a is a diagram depicting example headers associated with broadcast frames transmitted from station 410 to RAP 420 and from RAP 420 to DAP 430. A broadcast frame is a frame that is intended for all members of the wireless LAN identified by the BSSID of the AP that sent the frame. Broadcast frame header 710 for this example is transmitted from station 410 to RAP 420. Header 710 includes a To DS field with a value of ‘1’ and a From DS field with a value of ‘0’. Header 710 also includes three MAC address fields. MAC address 1 contains a BSSID value that identifies the AP 422 BSS. MAC address 2 contains a MAC source address value that identifies station 410. The MAC address 3 (destination address) field and the destination IP address field are filled with FFh values. The source IP address field contains a value that identifies station 410. RAP 420 sends this unicast frame only to DAP 430 which will send an actual broadcast within its BSSID, then RAP 420 will receive that broadcast and translate it for broadcast within its own BSSID.

RAP 420 receives header 710 and changes the MAC address 1 field and MAC address 2 field to create broadcast frame header 720. The MAC address 1 field is changed to identify the DAP 430 BSSID, and the MAC address 2 field is changed to identify eSTA 424 as the source. A frame associated with header 720 is transmitted by RAP 420 to DAP 430 via interconnect 403. Note that the frame is not broadcast by RAP 420 to its BSS at this time, but is delivered to DAP 430.

FIG. 7b is a continuation of FIG. 7a, and depicts example headers associated with broadcast frames transmitted from DAP 430 to all of the stations of WLAN 400. DAP 430 receives header 720 and in response generates broadcast frame header 730 that is transmitted to both RAP 420 and station 450. Header 730 includes a To DS field with a value of ‘0’ and a From DS field with a value of ‘1’. The MAC address 1 (MAC destination address) and destination IP fields are filled with FFh values. MAC address 2 contains a BSSID value that identifies the DAP 430 BSS. MAC address 3 contains a MAC source address that identifies eSTA 424. The source IP address field contains an address that identifies station 410.

In response to receiving header 730, RAP 420 generates broadcast frame header 740 that is transmitted along with its associated frame to all of the stations in the RAP BSS, which for this example includes stations 410 and 440. RAP 420 generates header 740 by changing the MAC address 2 field to identify the AP 422 BSS. RAP 420 may look at the ARP header's source IP address field to determine that this ARP reply is in response to a request that was sent by one of AP 422's locally associated and/or mapped stations, in this case STA 410, so in this case RAP 420 changes the MAC source address to correspond to the MAC address that is stored in the ARP header corresponding to STA 410. Otherwise, ARP replies received by eSTA 424 for this example may be in response to an ARP broadcast that originated with eSTA 424 itself, not with a STA associated with AP 422.

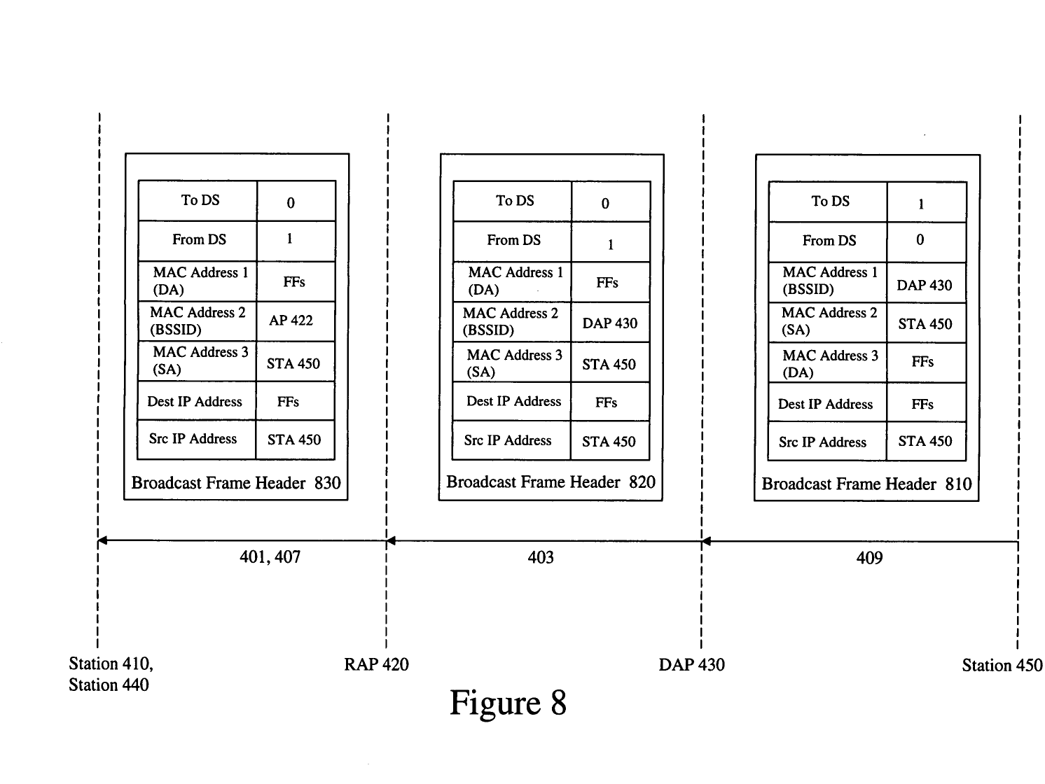

FIG. 8 is a diagram depicting an example header associated with a broadcast frame transmitted from station 450 to all of the stations in WLAN 400. Station 450 generates broadcast frame header 810 and transmits it and its associated frame to DAP 430. Header 810 includes a To DS field with a value of ‘1’ and a From DS field with a value of ‘0’. Header 810 also includes three MAC address fields. MAC address 1 contains a BSSID value that identifies the DAP 430 BSS. MAC address 2 contains a MAC source address value that identifies station 450. The MAC address 3 (destination address) field and the destination IP address field are filled with FFh values. The source IP address field contains a value that identifies station 450.

In response to receiving header 810, DAP 430 generates broadcast frame header 820 and transmits it and its associated frame to all stations in the DAP 430 BSS, which for this example includes eSTA 424. Header 820 includes a To DS field with a value of ‘0’ and a From DS field with a value of ‘1’. The MAC address 1 (MAC destination address) and destination IP fields are filled with FFh values. MAC address 2 contains a BSSID value that identifies the DAP 430 BSS. MAC address 3 contains a MAC source address that identifies station 450.

In response to receiving header 820, RAP 420 generates broadcast frame header 830 that is transmitted along with its associated frame to all of the stations in AP 422's BSS, which for this example includes stations 410 and 440. RAP 420 generates header 830 by changing the MAC address 2 field to identify the AP 422's BSSID. The source IP address field contains an address that identifies station 450, and because RAP 420's address mapping table does not recognize that IP address as corresponding to a station that is associated with AP 422, the MAC source address is preserved by RAP 420 in generating the broadcast frame within AP 422's BSS.

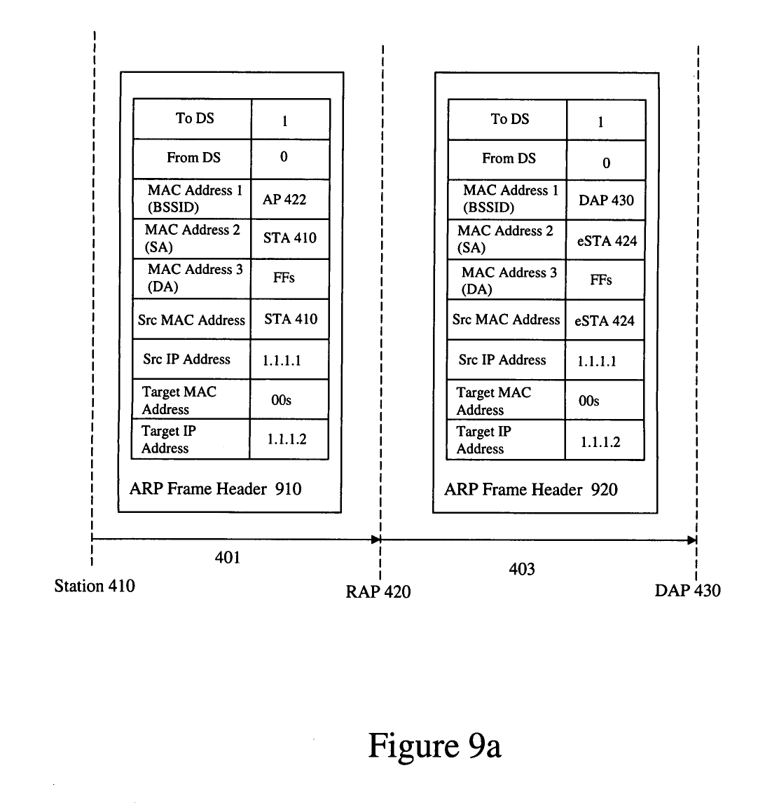

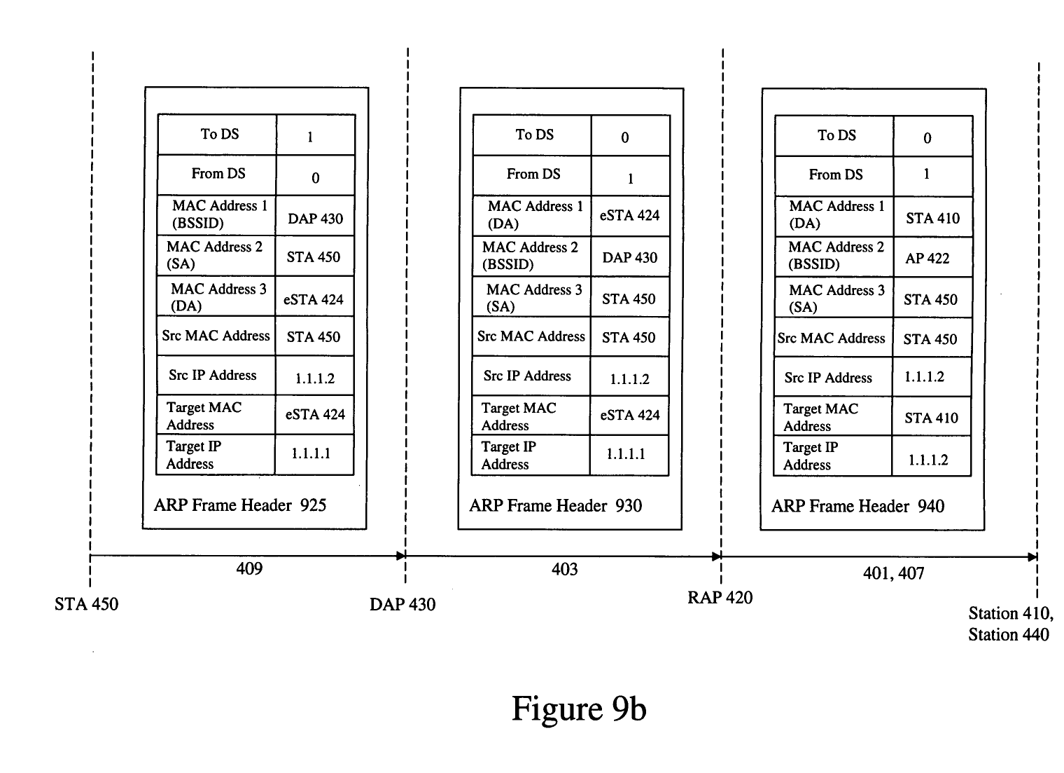

FIG. 9a is a diagram depicting example headers associated with address resolution protocol frames transmitted by station 410 in an effort to discover which station in WLAN 400 has an IP address indicated by the contents of a target IP address field. For this example, assume that station 410 has an IP address of 1.1.1.1 and that the target IP address is 1.1.1.2.

ARP frame header 910 is generated by station 410 and transmitted to RAP 420 along with a frame associated with header 910 via interconnect 401. Header 910 includes a To DS field with a value of ‘1’ and a From DS field with a value of ‘0’. Header 910 also includes a MAC address 1 field that contains a BSSID value identifying the AP 422 BSS. MAC address 2 contains a MAC source address value that identifies station 410. MAC address 3 (MAC destination address) is filled with FFh values. The ARP source MAC address field contains a value that identifies station 410. The ARP source IP address field contains the IP address of station 410, which for this example is 1.1.1.1. The ARP target MAC address field has a value of ‘0’. The ARP target IP address field has a value for this example of 1.1.1.2.

RAP 420 receives the frame including header 910, and in response generates ARP frame header 920, processing this broadcast for this example just as it did in the example depicted in FIGS. 7a and 7b, except that RAP 420 may harvest the information in the ARP header (i.e., the source MAC and source IP addresses) for use in its address mapping table. To generate header 920, RAP replaces the BSSID value in the MAC address 1 field with a value that identifies the DAP 430 BSS. The MAC address 2 and ARP source MAC address fields are modified to contain the address value that identifies eSTA 424.

FIG. 9b is a continuation of FIG. 9a. DAP 430 receives a frame including header 920 and in response broadcasts an ARP packet (not shown) to its client stations, including for this example station 450. Station 450 for this example has an IP address of 1.1.1.2 which matches the target IP address. Station 450 sends an ARP reply, including header 925, to DAP 430. Header 925 includes a To DS field with a value of ‘1’ and a From DS field with a value of ‘0’. Header 925 also includes a MAC address 1 field that contains a BSSID value identifying the DAP 430 BSS. MAC address 2 contains a MAC source address value that identifies station 450. MAC address 3 contains a MAC destination address value that identifies eSTA 424. The ARP source MAC address field contains a value that identifies station 450. The ARP source IP address field contains the IP address of station 450, which for this example is 1.1.1.2. The ARP target MAC address field contains an address value that identifies eSTA 424. The ARP target IP address field has a value for this example of 1.1.1.1. In response to receiving the reply including header 925, DAP 430 generates ARP frame header 930 which is transmitted along its associated frame as a broadcast, which is received by RAP 420. The To DS field for header 930 has a value of ‘0’. and the From DS field has a value of ‘1’. MAC address 1 contains a MAC destination address value that identifies eSTA 424. MAC address 2 contains a BSSID value that identifies the DAP 430 BSS. MAC address 3 contains a MAC source address value that identifies station 450. The ARP source MAC address field also contains a value that indicates station 450. The ARP source IP address field has a value of 1.1.1.2, and the ARP target IP address field has a value of 1.1.1.1. The ARP target MAC address field contains a MAC address value that identifies eSTA 424.

Header 930 and its associated frame are received by RAP 420, and in response RAP 420 generates header 940 which is transmitted along with its associated frame to station 410. RAP also transmits a frame (not shown) to station 440. To generate header 940, RAP 420 modifies the MAC address 1 field to include a value that indicates station 410. RAP 420 also updates the BSSID value in the MAC address 2 field to indicate the RAP BSSID (AP 422).

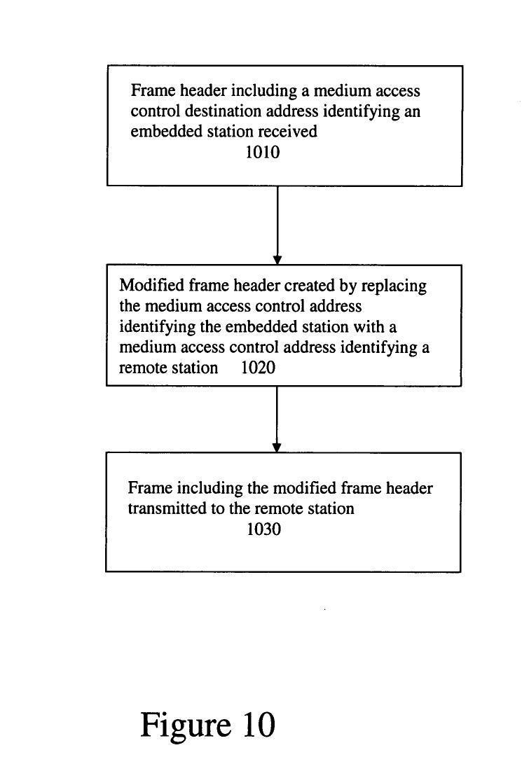

FIG. 10 is a flow diagram of an example embodiment of a method for communicating frames including headers from a distant access point to a remote station through a repeater access point. At block 1010, a frame header that includes a medium access control destination address identifying an embedded station is received. The frame header may be received from a distant access point at a repeater access point. At block 1020, a modified frame header is created by replacing the medium access control destination address identifying the embedded station with a medium access control address identifying a remote station. The new MAC address may be found by looking up the destination IP address in the repeater access point's address mapping table. At block 1030, a frame including the modified frame header is transmitted to the remote station.

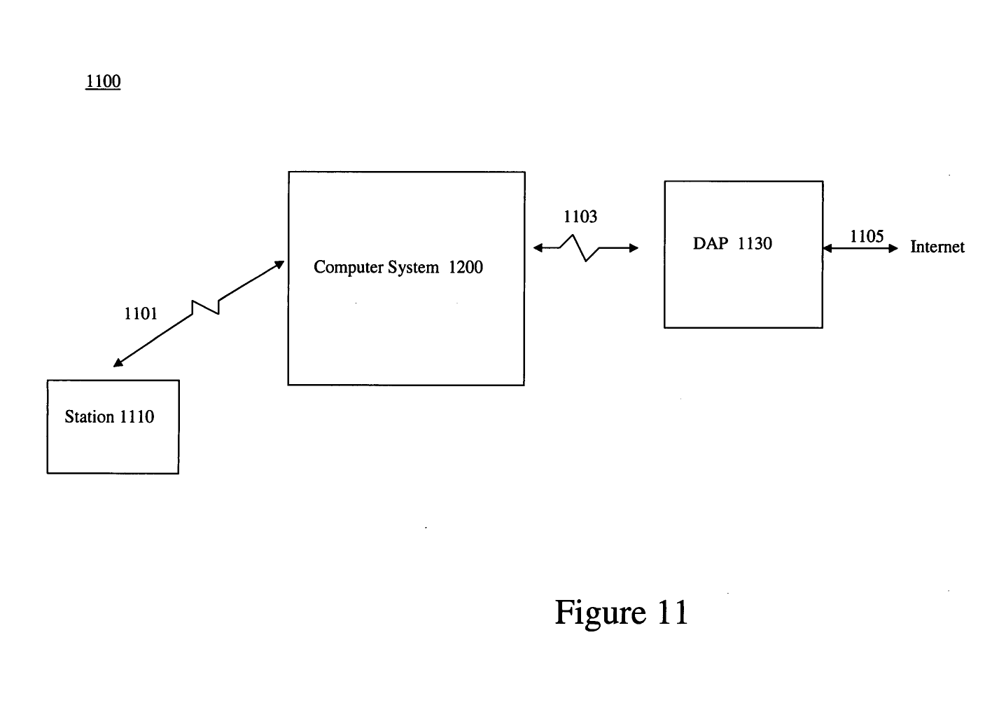

FIG. 11 is a block diagram of an example WLAN 1100 including an example embodiment of a computer system 1200. Computer system 1200 for this example includes repeater access point functionality to allow a station 1110 to communicate with a distant access point 1130. DAP 1130 is coupled to the Internet through a wired interconnect 1105. Station 1110 communicates with computer system 1200 via a wireless interconnect 1101. Computer system 1200 communicates with DAP 1130 via wireless interconnect 1103. Station 1110 and DAP 1130 may have properties similar to stations and distant access points discussed above in connection with FIGS. 1-10. Also, the repeater access point functionality included in computer system 1200 may have properties similar to repeater access point embodiments discussed above in connection with FIGS. 1-10.

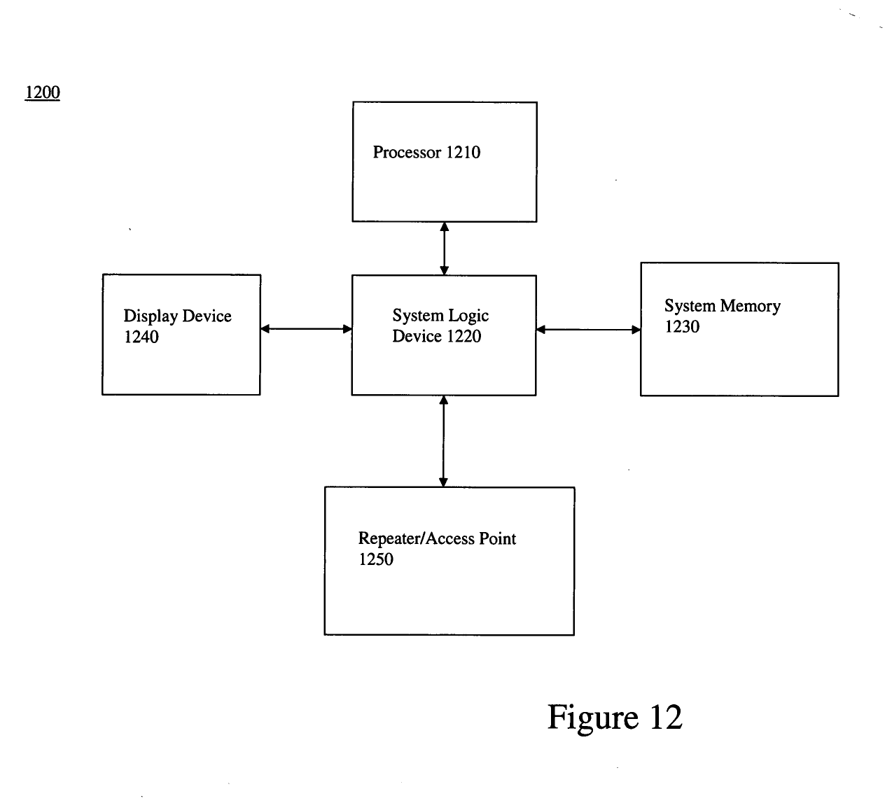

FIG. 12 is a block diagram of an example embodiment of a computer system 1200 including a repeater access point 1250. Repeater access point 1250 may have properties similar to the properties of repeater access point embodiments discussed above in connection with FIGS. 1-10. System 1200 includes a processor 1210 coupled to a system logic device 1220. A system memory 1230 and a display device 1240 may also be coupled to system logic device 1220. Although FIG. 12 shows a particular arrangement of system components, other embodiments are possible using a wide range of different components and/or arrangements of components.

System 1200 may comprise any of a wide range of devices, including, but not limited to, notebook computers, desktop computers, server computers, personal digital assistants, cellular phones, devices that include dedicated access point hardware, etc.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments.

In the foregoing specification claimed subject matter has been described with reference to specific example embodiments thereof. It will, however, be evident that various modifications and/or changes may be made thereto without departing from the broader spirit and/or scope of the subject matter as set forth in the appended claims. The specification and/or drawings are, accordingly, to be regarded in an illustrative rather than in a restrictive sense.

What is claimed is:

1. An apparatus, comprising:
an embedded station to receive a frame header via a first wireless interconnect, the frame header including a medium access control destination address identifying the embedded station;
an access point coupled to the embedded station; and
an address translation unit to create a modified frame header by replacing the medium access control destination address identifying the embedded station with a medium access control destination address identifying a remote station, the access point to transmit a frame including the modified frame header to the remote station via a second wireless interconnect.

2. The apparatus of claim 1, wherein the address translation unit uses a protocol destination address received with the frame header to determine the medium access control destination address identifying the remote station.

3. The apparatus of claim 2, wherein the address translation unit includes an address mapping table to store a plurality of medium access control addresses that are associated with a plurality of protocol addresses.

4. The apparatus of claim 3, the address translation unit to snoop an Address Resolution Protocol request packet to determine a medium access control address that corresponds to a protocol address, the address translation unit to store the determined medium access control address in the address mapping table.

5. The apparatus of claim 2, wherein the medium access control destination address adheres to the IEEE 802.11 standard.

6. The apparatus of claim 5, wherein the protocol destination address adheres to the Internet Protocol.

7. The apparatus of claim 1, wherein the frame header includes a first basic service set identification value, the address translation unit to replace the first basic service set identification value with a second basic service set identification value when creating the modified frame header.

8. A method, comprising:
receiving a frame header including a medium access control destination address identifying an embedded station;
creating a modified frame header by replacing the medium access control destination address identifying the embedded station with a medium access control address identifying a remote station; and
transmitting a frame including the modified frame header to the remote station.

9. The method of claim 8, wherein receiving a frame header includes receiving the frame header via a first wireless interconnect.

10. The method of claim 9, wherein receiving a frame header via a first wireless interconnect includes receiving the frame header from a distant access point.

11. The method of claim 8, wherein transmitting a frame includes transmitting the frame to a remote station via a second wireless interconnect.

12. The method of claim 8, wherein the frame header further includes a protocol destination address and wherein creating a modified frame header by replacing the medium access control destination address identifying the embedded station with a medium access control address identifying a remote station includes determining the medium access control address identifying the remote station using the protocol destination address.

13. The method of claim 12, further comprising storing a plurality of medium access control addresses that are associated with a plurality of protocol addresses in an address mapping table.

14. The method of claim 13, further comprising:
snooping an Address Resolution Protocol packet to determine a medium access control address that corresponds to a protocol address; and
storing the determined medium access control address in the address mapping table.

15. The method of claim 12, wherein the protocol destination address adheres to the Internet Protocol.

16. The method of claim 8, wherein receiving a frame header including a medium access control destination address identifying an embedded station includes receiving a frame header including a medium access control destination address that adheres to the IEEE 802.11 standard.

17. The method of claim 8, wherein receiving a frame header further includes receiving a frame header that includes a first basic service set identification value.

18. The method of claim 17, wherein creating the modified frame header further includes replacing the first basic service set identification value with a second basic service set identification value.

19. A system, comprising:
a processor;
a system logic device coupled to the processor;
a system memory coupled to the system logic device; and
a repeater/access point including
an embedded station to receive a frame header via a first wireless interconnect, the frame header including a medium access control destination address identifying the embedded station,
an access point coupled to the embedded station, and
an address translation unit to replace the medium access control destination address identifying the embedded station with a medium access control destination address identifying a remote station to create a modified frame header, the access point to transmit a frame including the modified frame header to the remote station via a second wireless interconnect.

20. The system of claim 19, wherein the address translation unit uses a protocol destination address received with the frame header to determine the medium access control destination address identifying the remote station.

21. The system of claim 20, wherein the address translation unit includes an address mapping table to store a plurality of medium access control addresses that are associated with a plurality of protocol addresses.

22. The system of claim 21, the address translation unit to snoop an Address Resolution Protocol packet to determine a medium access control address that corresponds to a protocol address, the address translation unit to store the determined medium access control address in the address mapping table.

23. The system of claim 19, wherein the frame header includes a first basic service set identification value, the address translation unit to replace the first basic service set identification value with a second basic service set identification value when creating the modified frame header.
